(19) United States
(12) Patent Application Publication
(10) Pub. No.: US 2015/0259971 A1
(43) Pub. Date: Sep. 17, 2015

(54) DOOR OF PLATFORM DOOR APPARATUS

(71) Applicant: MITSUBISHI HEAVY INDUSTRIES TRANSPORTATION EQUIPMENT ENGINEERING & SERVICE CO., LTD., Hiroshima (JP)

(72) Inventors: Haretaro HIDAKA, Hiroshima (JP); Kazuma YOSHIMOTO, Hiroshima (JP)

(21) Appl. No.: 14/657,666

(22) Filed: Mar. 13, 2015

(30) Foreign Application Priority Data
Mar. 14, 2014 (JP) 2014-051631

(51) Int. Cl. E06B 3/70; E04C 2/36; E06B 7/30; E06B 5/00

(52) U.S. Cl. CPC E06B 3/70; E06B 5/00; E04C 2/365; E06B 7/30

(57) ABSTRACT

A door part of a platform door apparatus includes: a panel member that has two metal plates and a honeycomb member sandwiched between the two metal plates; and a transparent member that has a transparent polycarbonate plate and a transparent glass plate thinner than the polycarbonate plate and entirely bonded to the polycarbonate plate and that is set in an opening formed in the panel member.

### CROSS-REFERENCE TO RELATED APPLICATIONS

This United States Non-Provisional Patent Application relies for priority on Japanese Patent Application No. 2014-051631, filed Mar. 14, 2014, the entire contents of which are incorporated herein by reference.

### FIELD OF THE INVENTION

The present invention relates to a door of a platform door apparatus to be installed on a platform.

### DESCRIPTION OF RELATED ART

A platform door apparatus is installed along the edge of a platform. After a train stops at the platform, the doors of the train open and door parts of the platform door apparatus open while passengers are getting in and out of the train, and the doors of the platform door apparatus are closed at other times. Thus, it is possible to prevent accidents including an accident in which passengers fall from the platform.

In some cases, various types of train cars in which the number of doors and the positions of doors are different stop at platforms of rail stations. Furthermore, because some stations have not introduced a system for controlling the train stop position, such as TASC (Train Automatic Stop-position Controller), and therefore a driver manually adjusts stopping of the train at those stations, the acceptable range for the train stop position might be wide. In order to install a platform door apparatus on those platforms, the opening width of the platform door apparatus needs to be wide. Accordingly, the extending/retracting length of each door part of the platform door apparatus is also increased.

### SUMMARY OF THE INVENTION

If the extending/retracting length of the door part of the platform door apparatus is increased, the weight of the door part is increased accordingly.

Furthermore, there is a demand to provide an opening in the door part of the platform door apparatus so that passengers and station staff can check, from both the platform side and the train car side, a bottom portion on the other side of the door part, even with the door part being closed, thereby enhancing safety and a sense of security. If a glass plate is set in the opening of the door part, although the glass plate is less likely to be scratched than a synthetic-plastic plate, this would increase the weight of the door part.

When the weight of the door part is increased, a motor for driving the door part is increased in size, and power consumption of the motor during operation is increased, which is not economical. Furthermore, the collision energy caused against the door part is increased as the weight of the door part is increased.

The present invention has been made in view of such circumstances, and an object thereof is to provide a door of a platform door apparatus that is capable of enhancing safety while achieving a reduction in weight of the door of the platform door apparatus.

In order to make an improvement in the above-described circumstances, the door of the platform door apparatus of the present invention adopts the following solutions.

Specifically, an aspect of the present invention provides a door of a platform door apparatus, the door including: a panel member that has two first plate members made of metal and a honeycomb member sandwiched between the two first plate members; and a transparent member that has a second plate member made of a transparent synthetic plastic plate and a third plate member made of a transparent glass plate thinner than the second plate member and bonded to the second plate member with its entire area, wherein the trasnparent member is fixed to an opening formed in the panel member.

According to this configuration, because the panel member has a honeycomb structure, it is possible to achieve a reduction in weight of the door and to enhance strength. Furthermore, because the transparent member is fixed to the opening formed in the panel member, passengers and station staff can check, from both the platform side and the train car side, a bottom portion on the other side of the door when the door is closed. Accordingly, safety and a sense of security can be enhanced.

Furthermore, the transparent member is a composite material having the second plate member, which is made of synthetic plastic, and the third plate member, which is made of glass. Therefore, the transparent member can achieve a reduction in weight and enhanced resistance to impacts and resistance to penetration, compared with a case in which the transparent member is composed of a glass plate member alone. Furthermore, the transparent member enhances bending rigidity and resistance to damage compared with a case in which the transparent member is composed of a synthetic-plastic plate member alone. Furthermore, because the second plate member and the third plate member are bonded to each other, and the adhesive layer is formed therebetween, the ultraviolet blocking properties and the noise insulation properties are enhanced compared with a case in which a single glass plate member or a single synthetic-plastic plate member is installed.

In the above-described aspect, the panel member may further includes a reinforcing part that is provided in the same plane as the honeycomb member and that is sandwiched between the two first plate members.

According to this configuration, when the reinforcing part has adequate strength to support the load of the door, and a supporting member for the door is installed at the reinforcing part, the door can be more stably supported compared with a case in which the supporting member for the door is directly installed at the honeycomb member.

According to this invention, it is possible to enhance safety while achieving a reduction in weight of the door of the platform door apparatus.

### BRIEF DESCRIPTION OF THE DRAWINGS

FIG. 1 is a plan view of a platform door apparatus according to an embodiment of the present invention, showing a state in which door parts are closed.

FIG. 2 is a plan view of the platform door apparatus according to the embodiment of the present invention, showing a state in which the door parts are open.

FIG. 3 is a front view showing a door part of the platform door apparatus according to the embodiment of the present invention.

FIG. 4 is a perspective view showing a panel member of the door part.

FIG. 5 is a perspective view showing a transparent member of the door part.

FIG. 6 is a sectional view cut along the line VI-VI in FIG. 3.

FIG. 7 is a partial sectional view cut along the line VII-VII in FIG. 3.

### DETAILED DESCRIPTION OF EMBODIMENTS OF THE INVENTION

A door part 2 of a platform door apparatus 1 according to an embodiment of the present invention will be described below with reference to the drawings.

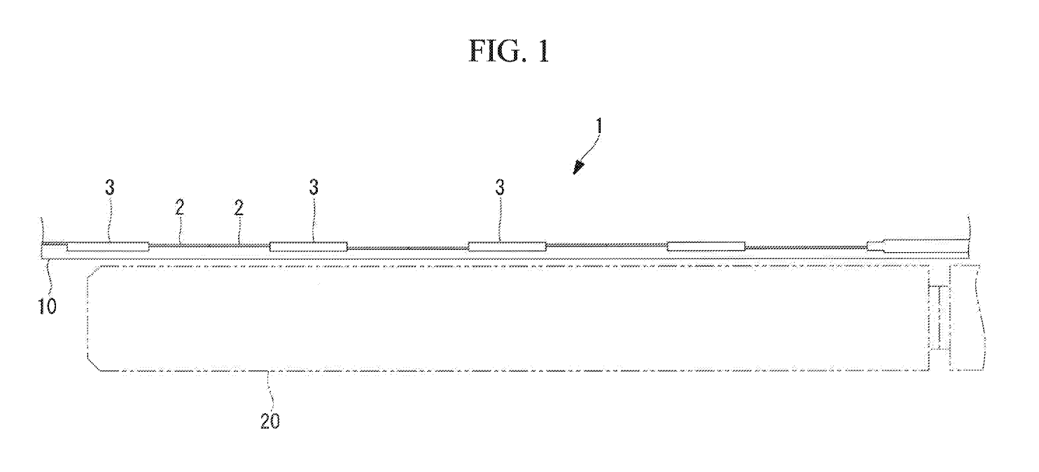

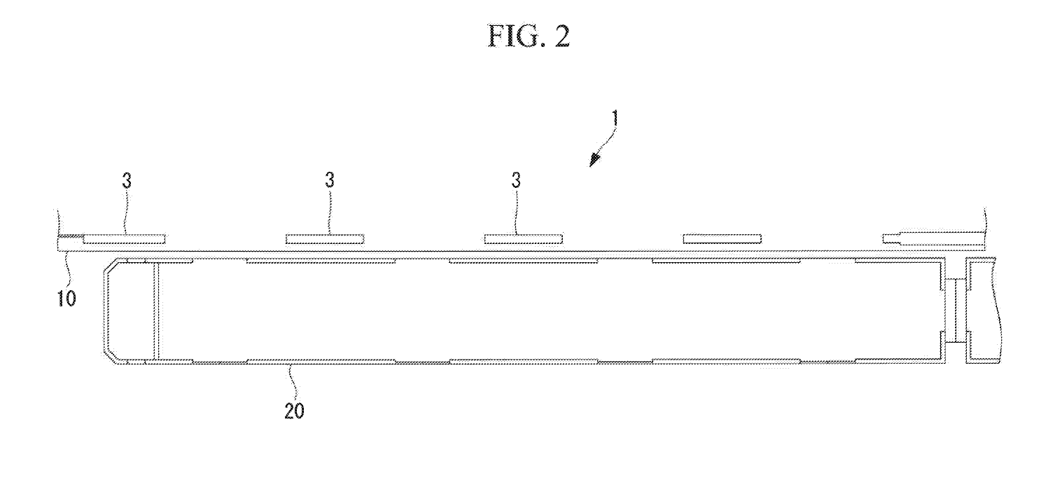

As shown in FIGS. 1 and 2, the platform door apparatus 1 is disposed along the edge of a platform 10 of a station at which a train 20 stops. The platform door apparatus 1 includes a plurality of door pocket portions 3 that are installed on the platform 10, and door parts 2 that are provided for the respective door pocket portions 3 and that extend from and retract into the door pocket portions 3.

The door parts 2 range from 1000 mm to 1100 mm in the height direction, and each of the door parts 2 ranges from 1300 mm to 3000 mm in the extending/retracting direction, for example. When each door part 2 is about 1700 mm in the extending/retracting direction, if part, i.e., 200 mm, of the door part 2 is still accommodated in the door pocket portion 3 in order to be supported by the door pocket portion 3, the door part 2 can cover half, i.e., 1500 mm, of the opening width, and, if the door parts 2 of the both sides have the same extending/retracting length, the opening width of the platform door apparatus 1 can be set to 3000 mm.

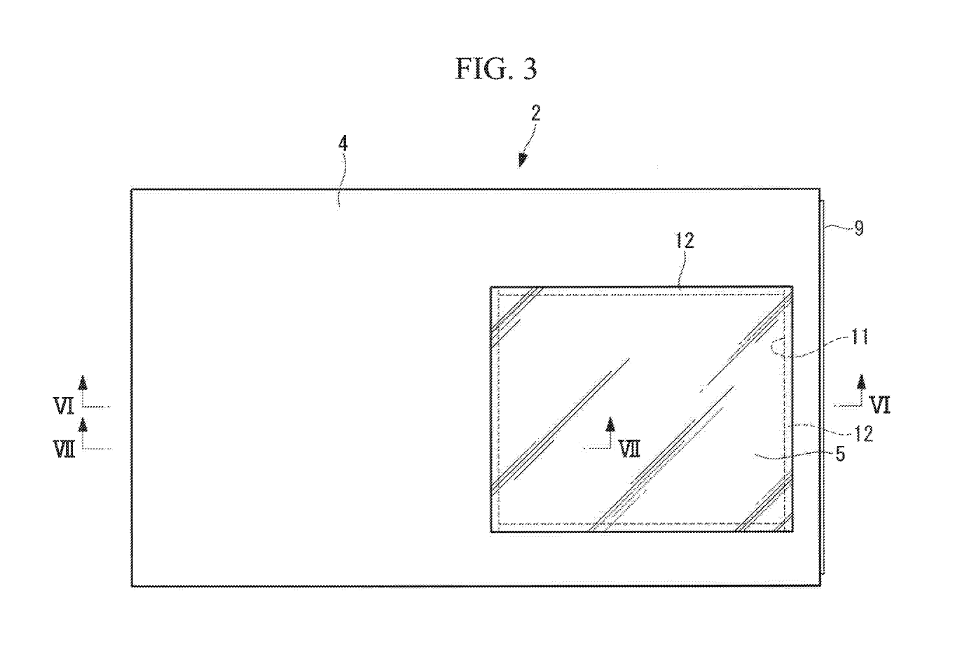

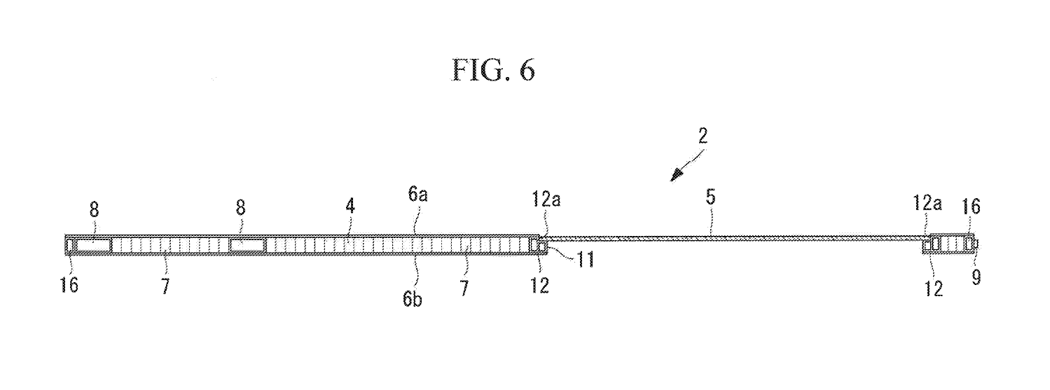

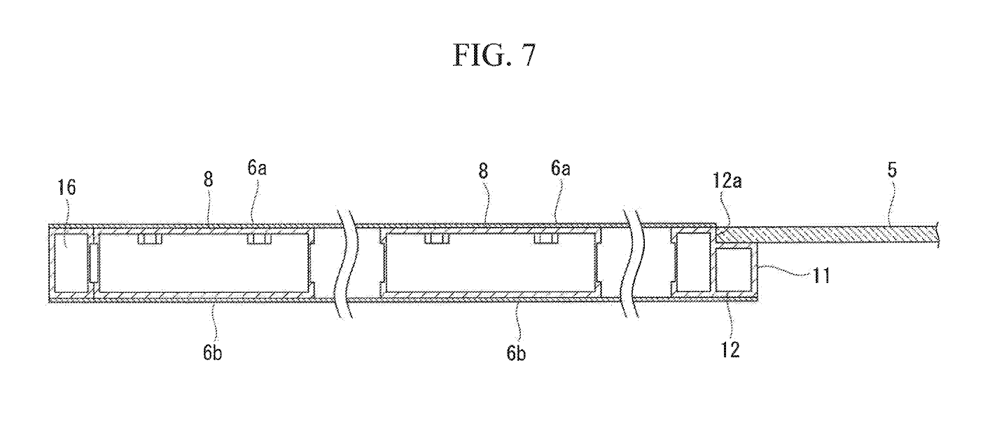

As shown in FIGS. 3, 6, and 7, the door part 2 of this embodiment is composed of a panel member 4, a transparent member 5, etc.

The panel member 4 is a rectangular plate-like member having a certain thickness. A doorstop rubber member 9 is provided on one side of the panel member 4. The panel member 4 is supported by the door pocket portion 3 via a slide rail, for example.

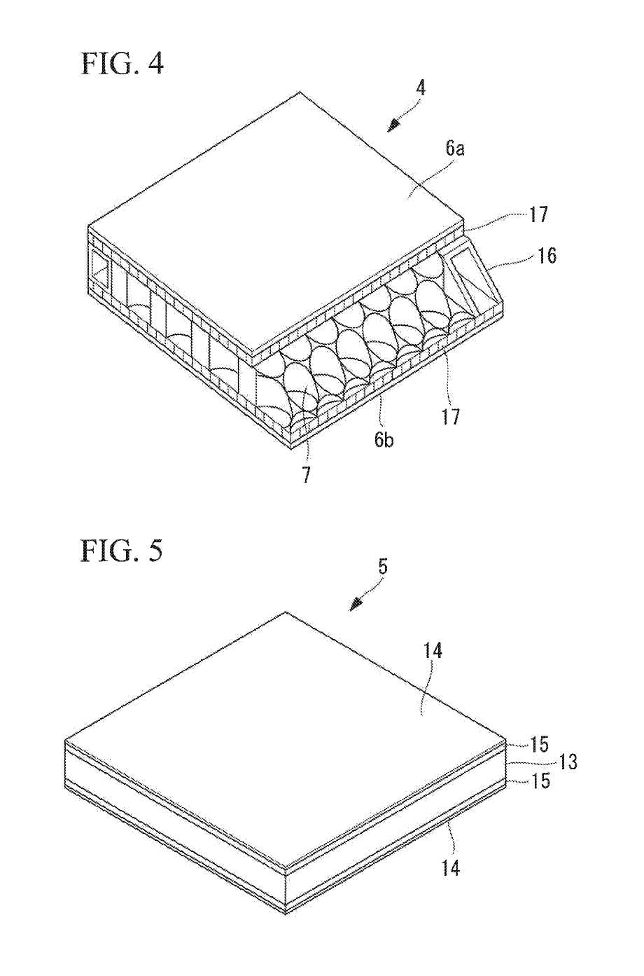

As shown in FIG. 4, the panel member 4 is composed of two metal plates (first plate members) 6a and 6b, which are made of metal, a honeycomb member 7 that is sandwiched between the two metal plates 6a and 6b, etc.

The metal plates 6a and 6b range from 2 mm to 3 mm in thickness, for example, and the metal plates 6a and 6b are made of aluminum alloy, for example.

The honeycomb member 7 is a member in which circular columns or polygonal columns formed of aluminum-alloy thin plates, for example, are densely disposed and has a thickness of about 30 mm. The metal plates 6a and 6b are bonded to both surfaces of the honeycomb member 7, respectively. The metal plates 6a and 6b and the honeycomb member 7 are bonded to each other with brazing filler metal 17, for example. The brazing filler metal 17 contains aluminum, for example, and has a low melting point.

As described above, because the panel member 4 has a honeycomb structure using the honeycomb member 7, it is possible to achieve a reduction in weight of the door part 2, compared with a panel member that has a similar rigidity with only rod-like frame members and plate members. Therefore, the panel member 4 can enhance strength while achieving a reduction in weight. Note that, in the panel member 4 of this embodiment, it is desirable that rod-like frame members 16 are appropriately disposed so as to maintain the overall shape, and it is not the case that the frame members 16 are not used at all. Note that the frame members 16 are made of the same material, for example, aluminum alloy, as the metal plates 6a and 6b and the honeycomb member 7, which are subjected to the brazing.

At portions of the door part 2 to which the slide rail is fixed, reinforcing parts 8 are provided in the panel member 4. The reinforcing parts 8 are provided in the same plane as the honeycomb member 7 and are installed so as to be sandwiched between the two metal plates 6a and 6b. The reinforcing parts 8 are made of plates thicker than the thin plates of the honeycomb member 7 and have a configuration which can be connected with bolts. Furthermore, the reinforcing parts 8 are provided at a plurality of places corresponding to the portions to which the slide rail is fixed, and the adequate strength to support the door part 2 is achieved by the plurality of reinforcing parts 8.

By providing the reinforcing parts 8, the door part 2 can be more stably supported compared with a case in which the slide rail is directly fixed to the metal plates 6a and 6b and the honeycomb member 7.

A method of manufacturing the panel member 4 is as follows, for example. First, the honeycomb member 7, the reinforcing parts 8, and the frame member 16 are disposed between the two metal plates 6a and 6b. At this time, the brazing filler metal 17 is applied between the metal plates 6a and 6b and the honeycomb member 7 etc. Then, by heating these members in a heat treatment furnace, the brazing filler metal 17 is melted, thus bonding and integrating the members. As a result, the panel member 4, which is composed of the honeycomb member 7 etc. sandwiched between the two metal plates 6a and 6b, is formed.

An opening 11 is formed in the panel member 4. When the door part 2 has a length of 1700 mm in the extending/retracting direction, the opening 11 ranges from 550 mm to 650 mm in the height direction and from 700 mm to 800 mm in the width direction, for example.

The transparent member 5 is fixed to the opening 11 formed in the panel member 4. Usual methods can be used to fix the transparent member 5 to the opening 11. For example, rod members 12 having a convex shape in cross section are disposed along the edges of the opening 11, and the transparent member 5 is glued to a stepped portion 12a thereof.

As shown in FIG. 5, the transparent member 5 has a transparent polycarbonate plate (second plate member) 13, transparent glass plates (third plate members) 14, etc.

The polycarbonate plate 13 ranges from 3 mm to 8 mm in thickness, for example. The polycarbonate plate 13 is an example of the second plate member made of synthetic plastic and may be made of a synthetic plastic other than polycarbonate.

Each of the glass plates 14 is thinner than the polycarbonate plate 13 and ranges from 0.1 mm to 0.5 mm in thickness, for example. The glass plate 14 is entirely bonded to one surface or both surfaces of the polycarbonate plate 13 with glue. An adhesive layer 15 is formed between the polycarbonate plate 13 and the glass plate 14.

Because the transparent member 5 is fixed to the opening 11 formed in the panel member 4, passengers and station staff can check, from both the platform 10 side and the train car side, a bottom portion on the other side of the door part 2 when the door part 2 is closed. Accordingly, safety and a sense of security can be enhanced.

The transparent member 5 is a composite material having the polycarbonate plate 13 and the glass plates 14 and has properties of both glass and synthetic plastic, as described below.

Specifically, in the transparent member 5, because the thickness of the glass plate 14 ranges from 0.1 mm to 0.5 mm, the total thickness of the transparent member 5 depends on the polycarbonate plate 13. Furthermore, because the density of polycarbonate is about half of glass, when a polycarbonate plate has the same thickness as glass, the weight of the polycarbonate plate can be about half of glass. Furthermore, because the Young's modulus of glass is about 27 times higher than that of polycarbonate, glass can has the same rigidity as polycarbonate with about one-third the thickness of polycarbonate.

Therefore, the transparent member 5 can achieve a reduction in weight compared with a case in which it is composed of a glass plate member alone, and can enhance the bending rigidity due to the reinforcing effect of the glass plates 14 as compared with a case in which the transparent member 5 is composed of a polycarbonate plate member alone. It was confirmed, by comparison using a three-point bending test, that the transparent member 5 of this embodiment exhibits less bending than a polycarbonate plate member.

The surfaces of the transparent member 5 are covered with the glass plates 14, thereby making it possible to enhance the resistance to damage and to maintain transparency for a long period of time, compared with a case in which only a polycarbonate plate member is installed in the opening 11. Regarding the resistance to damage, it was confirmed, by comparison using the Taber abrasion test, that the transparent member 5 of this embodiment is superior to a polycarbonate plate member. Specifically, when the transparent member 5 is installed in the opening 11 in the door part 2 of the platform door apparatus 1, because the surfaces of the transparent member 5 are covered with the glass plates 14, the transparent member 5 is less likely to be scratched compared with a case in which a single synthetic-plastic plate is installed in the opening 11 in the door part 2.

In the transparent member 5, because the glass plates 14 are bonded to the surfaces of the polycarbonate plate 13, the glass does not scattered when an impact force is applied thereto, and the resistance to impacts and the resistance to penetration can be enhanced compared with a case in which it is composed of a glass plate member alone. Regarding the resistance to impacts and the resistance to penetration, it was confirmed, by comparison using a falling ball test, that the transparent member 5 is superior to a glass plate member.

Furthermore, in the transparent member 5, because the polycarbonate plate 13 and the glass plates 14 are bonded to each other with glue, and the adhesive layer 15 is formed therebetween, the ultraviolet blocking properties and the noise insulation properties are enhanced compared with a case in which a single glass plate member or a single synthetic-plastic plate member is installed. Regarding the ultraviolet blocking properties, it was confirmed, from a frequency spectrum obtained in a verification test, that there are fewer ultraviolet components passing through the transparent member 5 compared with the case of a single glass plate member or a single synthetic-plastic plate member. Furthermore, regarding the noise insulation properties, it was confirmed, by a verification test, that the transmission loss is higher, particularly in the high-frequency range, when the transparent member 5 is used as compared with the case of a single glass plate member or a single synthetic-plastic plate member.

As described above, according to this embodiment, the door part 2 is composed of the panel member 4, the transparent member 5, etc. Thus, it is possible to enhance safety while achieving a reduction in weight of the door part 2 of the platform door apparatus 1.

Therefore, even if the extending/retracting length of the door part 2 of the platform door apparatus 1 is increased in a case in which the opening width of the platform door apparatus 1 needs to be increased, the weight increase can be suppressed by using the door part 2 of this embodiment.

Because the weight of the door part 2 can be reduced, it is possible to prevent an increase in the size of a motor for driving the door part 2 and a rise in power consumption of the motor during operation. Furthermore, the door part 2 can reduce the collision energy caused against people by reducing a weight increase of the door part 2.

1. A door of a platform door apparatus, the door comprising:
a panel member that has two first plate members made of metal and a honeycomb member sandwiched between the two first plate members; and
a transparent member that has a second plate member made of a transparent synthetic plastic plate and a third plate member made of a transparent glass plate thinner than the second plate member and bonded to the second plate member with its entire area, wherein the trasnparent member is fixed to an opening formed in the panel member.

2. A door of a platform door apparatus according to claim 1, wherein the panel member further comprises a reinforcing part that is provided in the same plane as the honeycomb member and that is sandwiched between the two first plate members.
